(19) United States
(12) Patent Application Publication
(10) Pub. No.: US 2025/0053873 A1
(43) Pub. Date: Feb. 13, 2025

(54) DATA EVALUATION FOR AI/ML

(71) Applicant: Nokia Technologies Oy, Espoo (FI)

(72) Inventors: Dick CARRILLO MELGAREJO, Lappeenranta (FI); Oana-Elena BARBU, Aalborg (DK)

(21) Appl. No.: 18/798,824

(22) Filed: Aug. 9, 2024

Related U.S. Application Data
(60) Provisional application No. 63/518,967, filed on Aug. 11, 2023.

(51) Int. Cl. G06N 20/00

(52) U.S. Cl. CPC G06N 20/00

(57) ABSTRACT

Example embodiments direct to data evaluation for AI/ML. A method comprises: at a first apparatus, receiving, from at least one second apparatus, bitmap information indicating respective locations of data samples collected by the at least one second apparatus, the at least one second apparatus being configured for data collection for an artificial intelligence (AI)/machine learning (ML) service; determining, based at least in part on the bitmap information, a quality level of data samples collected by the at least one second apparatus; selecting data samples to be included in a dataset for the AI/ML service by comparing the quality level with a target quality level for the dataset; and transmitting, to the at least one second apparatus, a request to report the selected data samples to be included in the dataset to a target entity.

### FIELDS

Various example embodiments of the present disclosure generally relate to the field of telecommunication and in particular, to methods, devices, apparatuses and computer readable storage medium for data evaluation for artificial intelligence (AI)/machine learning (ML).

### BACKGROUND

With developments of communication systems, new technologies have been proposed. For example, it has been proposed that artificial intelligence (AI)/machine learning (ML) can be applied to cellular networks. Data collection is essential to ML solutions to be implemented in the cellular networks for training, validating and testing purposes. For example, for AI/ML-based solutions dealing with positioning in 5G new radio (NR) system, the network needs to collect positioning related measurements conducted by user equipments (UEs). Such measurements can be conducted over a Uu interface between the network and UEs, i.e., uplink and downlink, as well as over a PC5 interface, i.e., sidelink, e.g., for ranging between two UEs. Thus, it is worthy studying on the mechanisms for data collection.

### SUMMARY

In a first aspect of the present disclosure, there is provided a first apparatus. The first apparatus comprises at least one processor; and at least one memory storing instructions that, when executed by the at least one processor, cause the first apparatus at least to perform: receiving, from at least one second apparatus, bitmap information indicating respective locations of data samples collected by the at least one second apparatus, the at least one second apparatus being configured for data collection for an artificial intelligence (AI)/machine learning (ML) service; determining, based at least in part on the bitmap information, a quality level of data samples collected by the at least one second apparatus; selecting data samples to be included in a dataset for the AI/ML service by comparing the quality level with a target quality level for the dataset; and transmitting, to the at least one second apparatus, a request to report the selected data samples to be included in the dataset to a target entity.

In a second aspect of the present disclosure, there is provided a second apparatus. The second apparatus comprises at least one processor; and at least one memory storing instructions that, when executed by the at least one processor, cause the second apparatus at least to perform: transmitting, to a first apparatus, bitmap information indicating respective locations of data samples collected by the second apparatus, the second apparatus being configured for data collection for an artificial intelligence (AI)/machine learning (ML) service; and receiving, from the first apparatus, a request to report data samples that are selected to be included in the dataset to a target entity.

In a third aspect of the present disclosure, there is provided a method. The method comprises: receiving, at first apparatus and from at least one second apparatus, bitmap information indicating respective locations of data samples collected by the at least one second apparatus, the at least one second apparatus being configured for data collection for an artificial intelligence (AI)/machine learning (ML) service; determining, based at least in part on the bitmap information, a quality level of data samples collected by the at least one second apparatus; selecting data samples to be included in a dataset for the AI/ML service by comparing the quality level with a target quality level for the dataset; and transmitting, to the at least one second apparatus, a request to report the selected data samples to be included in the dataset to a target entity.

In a fourth aspect of the present disclosure, there is provided a method. The method comprises: transmitting, at a second apparatus and to a first apparatus, bitmap information indicating respective locations of data samples collected by the second apparatus, the second apparatus being configured for data collection for an artificial intelligence (AI)/machine learning (ML) service; and receiving, from the first apparatus, a request to report data samples that are selected to be included in the dataset to a target entity.

In a fifth aspect of the present disclosure, there is provided a first apparatus. The first apparatus comprises means for receiving, from at least one second apparatus, bitmap information indicating respective locations of data samples collected by the at least one second apparatus, the at least one second apparatus being configured for data collection for an artificial intelligence (AI)/machine learning (ML) service; means for determining, based at least in part on the bitmap information, a quality level of data samples collected by the at least one second apparatus; means for selecting data samples to be included in a dataset for the AI/ML service by comparing the quality level with a target quality level for the dataset; and means for transmitting, to the at least one second apparatus, a request to report the selected data samples to be included in the dataset to a target entity.

In a sixth aspect of the present disclosure, there is provided a second apparatus. The second apparatus comprises means for transmitting, to a first apparatus, bitmap information indicating respective locations of data samples collected by the second apparatus, the second apparatus being configured for data collection for an artificial intelligence (AI)/machine learning (ML) service; and means for receiving, from the first apparatus, a request to report data samples that are selected to be included in the dataset to a target entity.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling flow for an example communication process in accordance with some embodiments of the present disclosure;

FIG. 3 illustrates an example of three different sub-datasets in accordance with some embodiments of the present disclosure;

FIG. 4 illustrates an example of bitmap approach in accordance with some embodiments of the present disclosure;

FIG. 5 illustrates a flowchart of a method implemented at a first apparatus according to some example embodiments of the present disclosure;

FIG. 6 illustrates a flowchart of a method implemented at a second apparatus according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

To facilitate understanding of the terminologies, some definitions of the list of terminologies used for AI/ML are provided below.

AI/ML Model: A data driven algorithm that applies AI/ML techniques to generate a set of outputs based on a set of inputs.

AI/ML model delivery: A generic term referring to delivery of an AI/ML model from one entity to another entity in any manner. Note: An entity could mean a network node/function (e.g., gNB, location management function (LMF), etc.), UE, proprietary server, etc.

AI/ML model Inference: A process of using a trained AI/ML model to produce a set of outputs based on a set of inputs.

AI/ML model testing: A subprocess of training, to evaluate the performance of a final AI/ML model using a dataset different from one used for model training and validation. Differently from AI/ML model validation, testing does not assume subsequent tuning of the model.

AI/ML model training: A process to train an AI/ML Model [by learning the input/output relationship] in a data driven manner and obtain the trained AI/ML Model for inference.

AI/ML model transfer: Delivery of an AI/ML model over the air interface in a manner that is not transparent to 3GPP signalling, either parameters of a model structure known at the receiving end or a new model with parameters. Delivery may contain a full model or a partial model.

AI/ML model validation: A subprocess of training, to evaluate the quality of an AI/ML model using a dataset different from one used for model training, that helps selecting model parameters that generalize beyond the dataset used for model training.

Data collection: A process of collecting data by the network nodes, management entity, or UE for the purpose of AI/ML model training, data analytics and inference.

Federated learning/federated training: A machine learning technique that trains an AI/ML model across multiple decentralized edge nodes (e.g., UEs, gNBs) each performing local model training using local data samples. The technique requires multiple interactions of the model, but no exchange of local data samples.

Functionality identification: A process/method of identifying an AI/ML functionality for the common understanding between the network and the UE. Note: Information regarding the AI/ML functionality may be shared during functionality identification. Where AI/ML functionality resides depends on the specific use cases and sub use cases.

Model activation: enable an AI/ML model for a specific function.

Model deactivation: disable an AI/ML model for a specific function.

Model download: Model transfer from the network to UE.

Model identification: A process/method of identifying an AI/ML model for the common understanding between the network (NW) and the UE. Note: The process/method of model identification may or may not be applicable. Note: Information regarding the AI/ML model may be shared during model identification.

Model monitoring: A procedure that monitors the inference performance of the AI/ML model.

Model parameter update: Process of updating the model parameters of a model.

Model selection: The process of selecting an AI/ML model for activation among multiple models for the same AI/ML enabled feature. Note: Model selection may or may not be carried out simultaneously with model activation.

Model switching: Deactivating a currently active AI/ML model and activating a different AI/ML model for a specific function.

Model update: Process of updating the model parameters and/or model structure of a model.

Model upload: Model transfer from UE to the network.

Network-side (AI/ML) model: An AI/ML Model whose inference is performed entirely at the network.

Offline field data: The data collected from field and used for offline training of the AI/ML model.

Offline training: An AI/ML training process where the model is trained based on collected dataset, and where the trained model is later used or delivered for inference. Note: This definition only serves as a guidance. There may be cases that may not exactly conform to this definition but could still be categorized as offline training by commonly accepted conventions.

Online field data: The data collected from field and used for online training of the AI/ML model.

Online training: An AI/ML training process where the model being used for inference) is (typically continuously) trained in (near) real-time with the arrival of new training samples. Note: the notion of (near) real-time vs. non real-time is context-dependent and is relative to the inference time-scale. Note: This definition only serves as a guidance. There may be cases that may not exactly conform to this definition but could still be categorized as online training by commonly accepted conventions. Note: Fine-tuning/re-training may be done via online or offline training. (This note could be removed when we define the term fine-tuning.)

Reinforcement Learning (RL): A process of training an AI/ML model from input (a.k.a. state) and a feedback signal (a.k.a. reward) resulting from the model's output (a.k.a. action) in an environment the model is interacting with.

Semi-supervised learning: A process of training a model with a mix of labelled data and unlabelled data.

Supervised learning: A process of training a model from input and its corresponding labels.

Two-sided (AI/ML) model: A paired AI/ML Model(s) over which joint inference is performed, where joint inference comprises AI/ML Inference whose inference is performed jointly across the UE and the network, i.e, the first part of inference is firstly performed by UE and then the remaining part is performed by the gNB, or vice versa.

UE-side (AI/ML) model: An AI/ML Model whose inference is performed entirely at the UE.

Unsupervised learning: A process of training a model without labelled data.

Proprietary-format models: ML models of vendor-/device-specific proprietary format, from 3GPP perspective. They are not mutually recognizable across vendors and hide model design information from other vendors when shared. Note: An example is a device-specific binary executable format.

Open-format models: ML models of specified format that are mutually recognizable across vendors and allow interoperability, from the 3GPP perspective. They are mutually recognizable between vendors and do not hide model design information from other vendors when shared.

As mentioned above, data collection is essential in cellular networks. The required data for training, validating, testing, and inferring from AI/ML solutions involve many data collection sources. In the case of solutions targeting 5G positioning, the network would have maintained AI/ML models, which however requires data to be collected from UEs or positioning reference units (PRUs).

The performance impact from availability of the ground truth labels (i.e., some training data may not have ground truth labels) is to be studied. The learning algorithm (e.g., supervised learning, semi-supervised learning, unsupervised learning) is to be reported by participating companies and, when providing evaluation results, data labelling details need to be described. The data labelling details include meaning of the label (e.g., UE coordinates; binary identifier of LOS/NLOS; ToA), percentage of training data without label (if incomplete labelling is considered in the evaluation), imperfection of the ground truth labels (if any).

Whether, and if so how, an entity can be used to obtain ground truth label and/or other training data is to be studied.

For direct AI/ML positioning, the impact of labelling error to positioning accuracy is studied. It needs to be considered that the ground truth label error in each dimension of x-axis and y-axis can be modelled as a truncated Gaussian distribution with zero mean and standard deviation of L meters, with truncation of the distribution to the [−2*L, 2*L] range. Value L is up to sources. Whether/how to study the impact of labelling error to label-based model monitoring methods needs to be considered. Whether/how to study the impact of labelling error for AI/ML assisted positioning needs to be considered.

For AI/ML assisted positioning with TOA as model output, the impact of labelling error to TOA accuracy and/or positioning accuracy needs to be studied. For example, the ground truth label error of TOA is calculated based on location error. The location error in each dimension of x-axis and y-axis can be modelled as a truncated Gaussian distribution with zero mean and standard deviation of L meters, with truncation of the distribution to the [−2*L, 2*L] range. Value L is up to sources. Moreover, other models of labelling error are not precluded. Other timing information, e.g., reference signal time difference (RSTD), as model output is not precluded.

For AI/ML assisted positioning with LOS/NLOS indicator as model output, the impact of labelling error to LOS/NLOS indicator accuracy and/or positioning accuracy needs to be studied. For example, the ground truth label error of LOS/NLOS indicator can be modelled as m % LOS label error and n % NLOS label error. Value m and n are up to sources. Companies consider at least hard-value LOS/NLOS indicator as model output.

Synthetic dataset generated according to the statistical channel models in 3GPP Technical Report (TR) 38.901 is used for model training, validation, and testing. The dataset is generated by a system level simulator based on 3GPP simulation methodology.

As a starting point, the training, validation and testing dataset are from the same large-scale and small-scale propagation parameters setting. Subsequent evaluations can study the performance when the training dataset and testing dataset are from different settings.

Details of the training dataset generation are to be reported. For example, the training dataset generation includes the size of training dataset, e.g., the total number of UEs in the evaluation area for generating training dataset. For another example, the distribution of UE location for generating the training dataset may be one of the following options. In one option, the distribution of UE location for generating the training dataset may be grid distribution, i.e., one training data is collected at the center of one small square grid, where, for example, the width of the square grid can be 0.25/0.5/1.0 m. In another option, the distribution of UE location for generating the training dataset may be uniform distribution, i.e., the UE location is randomly and uniformly distributed in the evaluation area.

For AI/ML-assisted positioning, companies report which construction is applied in their evaluation. One construction is single-Transmit/Receive Point (TRP) construction: the input of the ML model is the channel measurement between the target UE and a single TRP, and the output of the ML model is for the same pair of UE and TRP. Another construction is multi-TRP construction: the input of the ML model contains N sets of channel measurements between the target UE and N (N>1) TRPs, and the output of the ML model contains N sets of values, one for each of the N TRPs.

It is noted that for a measurement (e.g., RSTD) which is a relative value between a given TRP and a reference TRP, the TRP in “single-TRP” and “multi-TRP” refers to the given TRP only. For single-TRP construction, companies report whether they consider same models for all TRPs or N different models for TRPs.

When single-TRP construction is used for the AI/ML model, companies report at least the AI/ML complexity (model complexity, computation complexity) for N TRPs, which are used to determine the position of a target UE considering the various constructions.

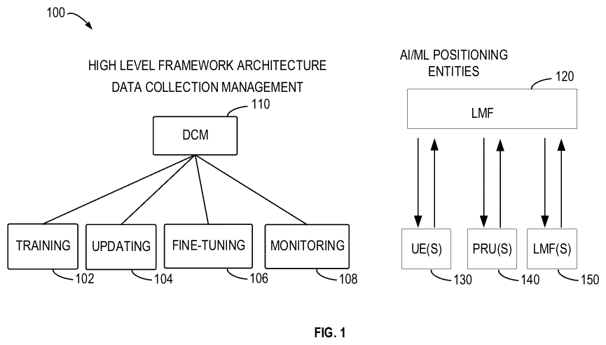

FIG. 1 illustrates an example communication environment 100 in which example embodiments of the present disclosure can be implemented. In the communication environment 100, high level framework architecture of a data collection management (DCM) 110 entity on different lifecycle management (LCM) steps of a model is shown, including training 102, updating 104, fine-tuning 106, and monitoring 108. To evaluate the goodness of data (such as positioning data) for training 102, updating 104, fine-tuning 106, and monitoring 108, the DCM 110 is provided which orchestrates the identification, collection, classification, and usage of datasets for positioning (measurements and its respective labeling information).

In the communication environment 100, AI/ML positioning entities may indicate the bidirectional signalization based on the data collection purposes between a LMF 120 and UE(s) 130, PRU(s) 140, or the same or other LMF(s) 150. It is noted that the PRU 140 is a UE with known location, and it is expected to have by default capabilities considering data collection. For convenience, the following will take the LMF 120 and the UE 130 as an example. In some example embodiments, the DCM 110 may be integrated in the LMF 120 although in other example embodiments, the DCM 110 and the LMF 120 may be separate entities.

In some example embodiments, during the UEs network entry, the UE 130 may report its capability (Conditions) on specific features or group of features related to AI/ML positioning. If between the reported capabilities is considered the data collection conditions (to indicate the measurements that can be gathered by the specific UE 130 and specific LCM 120 step supported), then a data collection method is triggered by the LMF 120 on the specific UE 130.

In some example embodiments, after the data collection method is triggered to a group of UEs in the same cell ID, the UEs receive a set of settings (e.g., PRS settings) to be considered during the data collection process.

In the following, for the purpose of illustration, some example embodiments are described with the UE 130 operating as a terminal device and the LMF 120 operating as a network device. However, in some example embodiments, operations described in connection with a terminal device may be implemented at a network device or other device, and operations described in connection with a network device may be implemented at a terminal device or other device.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

When training a supervised learning model to solve a certain task such as a positioning task, in order to achieve high positioning accuracy, it is necessary that the UEs from which training data is collected are uniformly distributed in the geographical area of interest. Studies have been shown that models trained with the same UE density (i.e., same number of samples per m2), but with two different UE distributions exhibit wide performance variations. Specifically, if the UE distribution is not uniform, the positioning performance degradation becomes severe, with model accuracy degrading by up to 55% compared to the case in which the model is trained with uniformly distributed UEs. It is therefore a prerequisite that the training data is collected from UEs uniformly distributed in space i.e., that the training data labels generated by simulation obeys a uniform distribution in the spatial region for which the positioning model is being trained.

In addition to the distribution behavior of the labels, other factors contribute to the quality level (or goodness) of a dataset for an AI/ML service. Such a dataset may sometimes be referred to as a training dataset although it would be appreciated that the dataset may be utilized for training, updating, fin-tuning, monitoring, validation, test, and/or any other aspects related to an AI/ML model.

It is noted that by referring to “quality”, “quality level” or “goodness” of a dataset for an AI/ML model, it refers to the training data property to cause accurate model performance, such as accurate positioning AI/ML positioning models.

There are example factors that contribute to the training data goodness. For example, input features (e.g., CIR, RSRPP, RSTD, etc.) of the training data should have a minimum quality. To ensure that, the input features should be estimated from signals collected in a medium/high SINR regime. For another example, if the labels are also estimated quantities, then a minimum label quality should also be ensured.

In sum, an AI/ML positioning model accuracy is limited by the quality of the training data, i.e., the size of the training data and/or the diversity of the training data. The diversity of the training data includes the quality of the input features and of the labels and the distribution of the labels.

Thus, it is beneficial that, prior to training an AI/ML model, the available data is assessed for quality. Based on the assessment results, it may decide whether the data can be used for training and/or whether the data should be split and used for training multiple AI/ML models.

According to some example embodiments of the present disclosure, there is provided a solution for data evaluation for AI/ML. At least one second apparatus (terminal devices such as UEs and/or PRUs) may be configured for data collection for an artificial intelligence (AI)/machine learning (ML) service. A first apparatus such as the LMF or DCM, receives, from the at least one second apparatus, bitmap information indicating respective locations of data samples collected by the at least one second apparatus. The first apparatus determine, based at least in part on the bitmap information, a quality level of data samples collected by the at least one second apparatus, and select data samples to be included in a dataset for the AI/ML service by comparing the quality level with a target quality level for the dataset. The first apparatus transmits, to the at least one second apparatus, a request to report the selected data samples to be included in the dataset to a target entity. The at least one second apparatus may then transmit the collected and selected data samples which have met the target quality level, to an entity requiring the dataset. Such an entity may be the LMF, a RAN node (e.g., gNB), a UE, or any other device which requires the collected data for AI/ML model training, updating, fine-tuning, or the like.

Through the solution, before the collected data samples are reported, the bitmap information is needed from the apparatuses which collect data, to guide the dataset collection and reporting to achieve the data collection target. This can reduce signaling overhead between the apparatuses and to allow the quality of the reported data samples meets with the target.

In some example embodiments, a network (NW)-led procedure to orchestrate positioning data collection may be proposed and the goodness of positioning data (for training, updating, fine-tuning a model) may be evaluated. Then, based on the continuous evaluation outcome, how the data should be collected at the next collection instance (i.e., time resolution of the collection, distribution of UEs from which data is being collected, etc) may be decided. Based on the continuous evaluation outcome, how the data should be used after collection, for teaching one or more AIML models to solve one or more positioning tasks, may be decided.

Example embodiments of the present disclosure will be described in detail below with reference to the accompanying drawings.

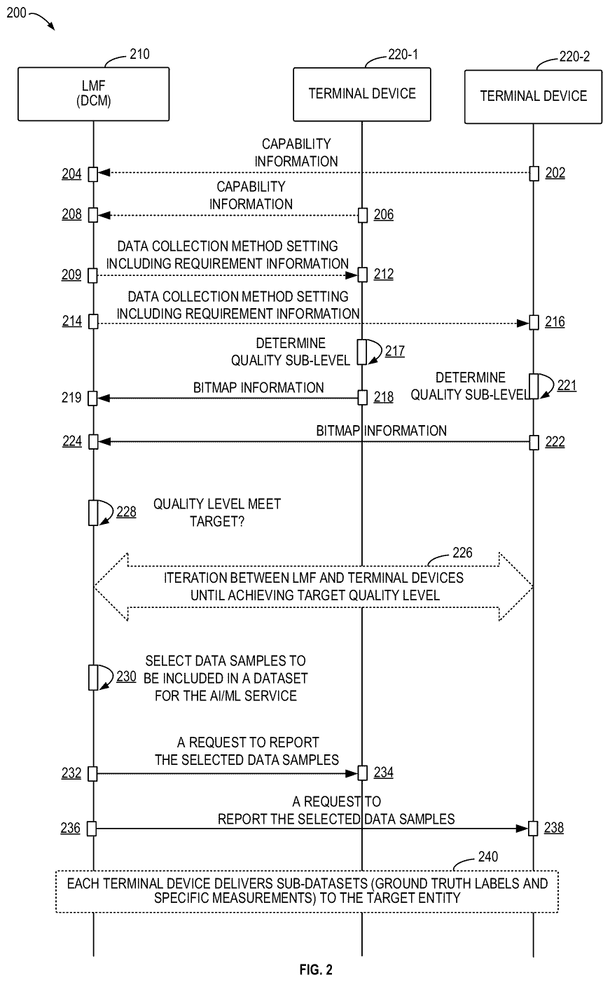

FIG. 2 illustrates a signaling flow 200 for an example communication process in accordance with some embodiments of the present disclosure. The signaling flow 200 involves a LMF 210 (which may include a DCM), and one or more terminal devices 220-1, 220-2 (collectively or individually referred to as terminal devices 220). In some example embodiments, the LMF 210 may be replaced with the DCM. In some example embodiments, the terminal devices 220 may include one or more UEs, PRUs, and/or other entities which can be configured to collect and report data samples for an AI/ML service. Although two terminal devices 220 are illustrated, it would be appreciated that there may be more or less terminal devices.

In FIG. 2, the terminal device 220-1 transmits (218) bitmap information. The terminal device 220-2 transmits (222) a bitmap information. Correspondingly, the LMF 210 receives (219) the bitmap information from the terminal device 220-1 and receives (224) the bitmap information from the terminal device 220-2. Such bitmap information may indicate respective locations of data samples collected by each terminal device 220. The terminal devices 220 may be configured for data collection for an artificial intelligence (AI)/machine learning (ML) service. In some example embodiments, the AI/ML service may comprise an AI/ML positioning service, although other AI/ML services in the communication system may also be applicable.

In some example embodiments, to configure the terminal devices 220 for data collection, the LMF 210 may transmit (209) a data collection method setting including requirement information to the terminal device 220-1. The LMF 210 may transmit (214) a data collection method setting including requirement information to the terminal device 220-2. If the reported capabilities is considered the data collection conditions (to indicate the measurements that can be gathered by the specific terminal device and specific LCM step supported), then a data collection method setting is triggered by the LMF on the specific terminal device. Correspondingly, the terminal device 220-1 receives (212) the data collection method setting and the terminal device 220-2 receives (216) the data collection method setting from the LMF 210 respectively.

In some example embodiments, the data collection method setting may comprise a requirement information for data collection which at least indicates the target radio quality range. For AI/ML direct positioning, in an embodiment, if available, every terminal device performing the dataset collection includes the time stamp and ground truth labeling (2D/3D position) mapped on specific measurements (e.g., CIR, PDP, DP, RSRP). Optionally, in another embodiment, every terminal device 220 performing the dataset collection includes the time stamp and ground truth labels for the AIML-assisted positioning task (e.g., TOA; LOS) mapped on specific measurements (e.g., CIR, PDP, DP, RSRP).

In some example embodiments, each terminal device 220 may determine (217, 221) a quality sub-level of the collected data samples and select the data samples that have meet the quality sub-level in the requirement information. In some example embodiments, every terminal device 220 evaluate a quality sub-level for the sub-dataset that has been collected locally. In some example embodiments, the quality sub-level determined at the terminal device 220 (which may be referred to as a third quality sub-level sometimes) may comprise a target radio quality range configured for the terminal devices 220 to select the data samples indicated in the bitmap information.

For instance, a range of SINR is considered to define the quality sub-level of Q1. Only the samples that achieve this quality target are considered in every sub-dataset stored locally in every terminal device 220. The terminal devices 220 may select the data samples to be indicated in the bitmap information according to the requirement information. For example, the terminal device 220 may select data samples with respective radio qualities within the target radio quality range.

In some example embodiments, every terminal device 220 sends a bitmap of its locations to the DCM located in the LMF 210. It is noted that only the bitmap information is transmitted without any measurement delivery or data sample delivery.

In some example embodiments, the bitmap information (or simply a bitmap) from the terminal devices 220 may comprise a plurality of bits corresponding to a plurality of location grids within a geographic area, respectively. A bit may be set with a first value or a second value to indicate whether a data sample is collected by the terminal devices 220 in a corresponding location grid.

In FIG. 2, the LMF 210 may determine a quality level of data samples collected by the terminal devices 220 based at least in part on the bitmap information and determine (228) whether the quality level of data samples collected by the terminal devices 220 satisfy the target quality level. The LMF 210 may determine an aggregated quality level of the data samples from multiple terminal devices 220 (quality levels of sub-datasets at respective terminal devices), to assess an aggregated quality level of the whole dataset.

In some example embodiments, in accordance with a determination that the quality level fails to satisfy the target quality level, the LMF 210 may transmit, to the terminal devices 220, a request to update the collected data samples. The LMF 210 may receive updated bitmap information from the terminal devices 220. The updated bitmap information may indicate respective locations where the updated data samples are collected by the terminal devices 220. The LMF 210 may update the quality level based at least in part on the updated bitmap information. The LMF 210 may select data samples to be included in the dataset for the AI/ML service by further comparing the updated quality level with the target quality level.

In some example embodiments, in accordance with a determination that the quality level satisfies the target quality level, the LMF 210 may select data samples to be included in the dataset for the AI/ML service from data samples indicated by the bitmap information.

That is, the LMF 210 may determine, based on the bitmap information, a quality level of data samples. Then, the LMF 210 compares the quality level with a target quality level. If the determined quality level does not achieve the target quality level, the LMF 210 performs (226) iteration between the LMF 210 and the terminal devices 220 until achieving target quality level.

In FIG. 2, the LMF 210 may select (230) data samples to be included in a dataset for the AI/ML service by comparing the quality level with the target quality level for the dataset.

In FIG. 2, the LMF 210 may transmit (232) a request to report the selected data samples to the terminal device 220-1. The LMF 210 may transmit (236) a request to report the selected data samples to the terminal device 220-2. Such data samples may be included in the dataset to a target entity. Correspondingly, the terminal device 220-1 receives (234) the request and the terminal device 220-2 receives (238) the request respectively.

In some example embodiments, the LMF 210 may transmit confirmation information to the terminal devices 220. Such confirmation information may be related to the data samples to be included in the dataset. The confirmation information at least comprises the bitmap information used for selecting the data samples. In some example embodiments, the LMF 210 may transmit confirmation information together with a request to the terminal devices 220.

In some example embodiments, the LMF 210 may receive identification information from the terminal devices 220. Such identification information may indicate at least one geographic area where the data samples are collected. The LMF 210 may determine, based on the identification information, an aggregated area within which data samples are selected to be included in the dataset. The LMF 210 may selecting the data samples that are collected within the aggregated area. That is, during the procedure above, the terminal devices 220 may transmit identification information together with the bitmap information.

In some example embodiments, the LMF 210 210 may integrate the bitmap information received from several terminal devices 210 and provides feedback to each terminal device 220 based on the target quality level requirements (e.g., samples/m2, terminal device 220 positioning distribution of ground truth labels) defined for every specific dataset (e.g., dataset id_1), in other words, the LMF 210 evaluate the QL and dataset size targets. Here, it is expected some interaction between the LMF 210 and terminal devices 210 to set different PRS until the target quality levels have been achieved.

These requirements or factors used to estimate the goodness can vary for each data collection used to enable any specific LCM step, such as model training, monitoring, or updating/fine-tuning. In some example embodiments, the target quality level is determined based on a usage of the dataset in the AI/ML service. For instance, if the purpose of the dataset is for training of an AI/ML model, the quality level may be set to higher than the target quality level used in collecting a dataset for monitoring. The requirements can be for instance, specific terminal devices 210 distribution (e.g., uniform distributed terminal devices 210) and signal quality on the receiver side (e.g., SINR), which should be weighted average accordingly to the target in the LCM step.

One aggregated and unique target quality level may be determined with the following equation:

$$\begin{matrix}{x}_{uf} = Ql ( {Ql}_{w} ) + Qi ( {Qi}_{w} ) + D ( {D}_{w} ) \\ ( {Ql}_{w} ) + ( {Qi}_{w} ) + ( {D}_{w} ) = 1\end{matrix}$$

where:
x_{uf}: the unique factor of target quality level;
Ql: minimum label quality of the dataset distribution (also referred to as a dataset distribution requirement);
Ql_{w}: weight of the minimum label quality of the dataset distribution;
Qi: minimum quality of radio measurements (e.g., SINR range, QCI range, RSRP range, etc.) (also referred to as a radio quality requirement);
Qi_{w}: weight of the minimum quality of radio measurements;
D: predetermined minimum density (also referred to as a density requirement); and
D_{w}: weight of the predetermined minimum density.

For example, in the case of training step in the LCM framework Ql_{w}=0.4, Qi_{w}=0.3, D_{w}=0.3; in other example for monitoring step in the LCM framework Ql_{w}=0.2, Qi_{w}=0.6, D_{w}=0.2. It would be appreciated that the values are provided as an example and other values may be configured.

In some example embodiments, the target quality level may be determined based on a target dataset size required by the dataset to be collected. The LMF 210 may require the terminal device 220 to collect enough data samples, or may select enough data sample from the collected data samples, until the target data size is satisfied.

In some example embodiments, the LMF 210 may determine, based at least in part on the bitmap information, at least one of the following: a first quality sub-level corresponding to a dataset distribution requirement of the dataset, a second quality sub-level corresponding to a density requirement of the dataset, a third quality sub-level corresponding to a radio quality requirement of the dataset, and a fourth quality sub-level corresponding to a target dataset size required by the dataset. The LMF 210 may determine the quality level based on a weighted aggregation of the at least one of the first, second, third, and fourth quality sub-levels. The determined quality level may reflect the quality of the currently collected data samples at the side of the terminal devices 220. The aggregation of the quality sub-levels may follow the same way as in determining the target quality level.

In some example embodiments, the dataset distribution requirement may indicate a uniform distribution of data samples. The LFM 210 may be caused to determine an overall distribution of the data samples collected by the terminal devices 220 based on the bitmap information. The LFM 210 may be caused to determine the first quality sub-level based on a similarity between the determined distribution and the uniform distribution. It is expected that the data samples are collected following a uniform distribution. Thus, if the determined distribution approximates to the uniform distribution, then the quality sub-level may be determined as a high level.

In some example embodiments, the LMF 210 may determine, based on the bitmap information, a total number of data samples collected by the terminal devices 220 and a total area size where data samples collected by the terminal devices 220. The LMF 210 may determine a density of data samples collected by the terminal devices 220 based on the total number of data samples and the total area size. The LMF 210 may determine the second quality sub-level based on a difference between the determined density and the density requirement.

In some example embodiments, the LMF 210 may determine, based on the bitmap information, a total number of data samples collected by the terminal devices 220. The LMF 210 may determine the fourth quality sub-level by comparing the determined total number of data samples to the target dataset size required by the dataset.

In some example embodiments, the quality level may be determined based on a weighted aggregation of at least one of the first, second, and third quality sub-levels. The LMF 210 may determine whether a total number of data samples collected by the terminal devices 220 satisfy a target dataset size required by the dataset. In accordance with a determination that the total number of data samples satisfies the target dataset size and in accordance with a determination that the quality level satisfies the target quality level, the LMF 210 may select data samples to be included in the dataset.

In some example embodiments, a high quality level (or goodness) of the training data may be referred to cause accurate positioning AIML positioning models. The goodness is defined by a set of metrics which are outlined herein and detailed in the next section as well.

In some example embodiments, “teaching to solve” any operation may be referred that changes the outcome of using an AI/ML model (e.g., training, updating, refining an AIML model for a positioning task).

In some example embodiments, the quality level (or goodness) of positioning training data may be defined as training data labels (where a label may be the 2D position, 3D position, TOA of a UE, etc.). For example, a selected distribution may be followed in a range R e.g., uniform distribution Unif(R), where R characterizes the geographical area for which an AI/ML positioning model is trained. For another example, a minimum label quality Q1 may be included.

In some example embodiments, the quality level (or goodness) of positioning training data may be defined as training data input features (e.g., impulse response (CIR), reference signal received power (RSRP), reference signal received power per path (RSRPp), power delay profile (PDP), delay profile (DP)) have a minimum quality, where the quality Qi is dependent on at least the SINR regime of the received positioning signals. To ensure Qi, the PRS should be collected in an SINR regime characterized by a range Rsinr=[SINRmin, SINRmax].

In some example embodiments, the goodness of positioning training data may be defined as training dataset size S or density D reach predetermined minima, where density is described as number of samples per m² e.g., number of CIR estimates obtained per m².

Still referring to FIG. 2, after the procedure above, each terminal device 220 delivers (240) sub-datasets (ground truth labels and specific measurements) to the target entity.

In some example embodiments, before the procedure above, the terminal device 220-1 transmits (202) a capability information. The terminal device 220-2 transmits (206) a capability information. The terminal devices 220 report its capability (Conditions) on specific features or group of features related to AI/ML positioning. Correspondingly, the LMF 210 receives (204) the capability information from the terminal device 220-1 and receives (208) the capability information from the terminal device 220-2.

In some example embodiments, the data assessment for quality aims to guarantee a minimum of dataset quality to maximize the AI/ML performance based on the LCM step (e.g., training, monitoring, fine-tuning). This assessment is used to attach to the dataset_ID specialized metadata information, such as the distribution of ground truth labels, and some radio KPIs as SINR for each link included in the dataset.

In some example embodiments, the DCM manages the construction of any specific dataset identified with dataset_ID, this identification aims to facilitate the storage and usage on every LCM step. Using only bitmap information in the LMF, the signalization overhead impact is reduced. The selection of specific ground truth labels and its respective measurements enhance an efficient usage of the protocol that deliver the dataset between entities if needed.

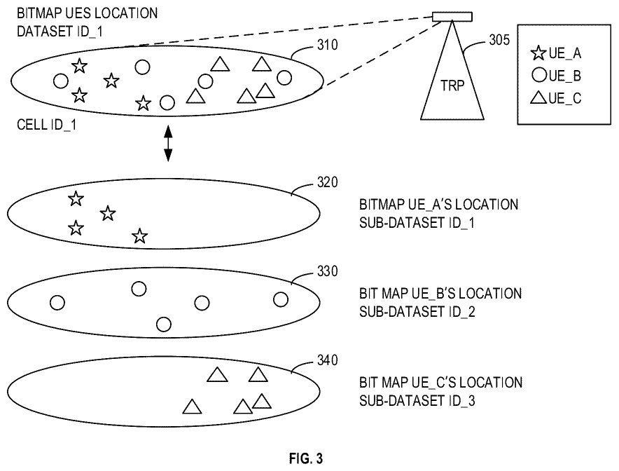

FIG. 3 illustrates an example of three different sub-datasets in accordance of the present disclosure. Dataset 310 may be aggregated from a sub-dataset 320 from UE_A, a sub-dataset 330 from UE_B and a sub-dataset 340 from UE_C. The sub-dataset 320 corresponds to a bitmap indicating locations of UE_A, with sub-dataset ID_1. The sub-dataset 330 corresponds to a bitmap indicating locations of UE_B, with a sub-dataset ID_2. The sub-dataset 340 corresponds to a bitmap indicating locations of UE_C, with a sub-dataset ID_3.

In FIG. 3, each sub-dataset related to a unique entity doing data collection (e.g., UEs, PRUs, and/or LMF). The target is to evaluate the UE locations (ground truth) mapped to a bitmap. The bitmap is used to enable the UE distribution analysis in the following steps.

In FIG. 3, the sub-datasets mentioned in the example are local IDs considered on every specific TRP 305 (with Cell ID_1). Thus, it is expected that other TRP (Cell ID) can reuse similar identification, but always maintaining it in the local scope. In the opposite direction, the dataset_ID (e.g., dataset id_1) aims to identify a dataset 310 with a regional scope. Several Cell_IDs may be mapped by the same dataset_ID.

In some example embodiments, for a bitmap from a terminal device 220 which is corresponding a certain geographic area, a grid granularity for the plurality of location grids within the geographic area is determined based on a requirement for the dataset. A geographic area may correspond to a cell where the terminal device 220 locates and identified by the cell ID.

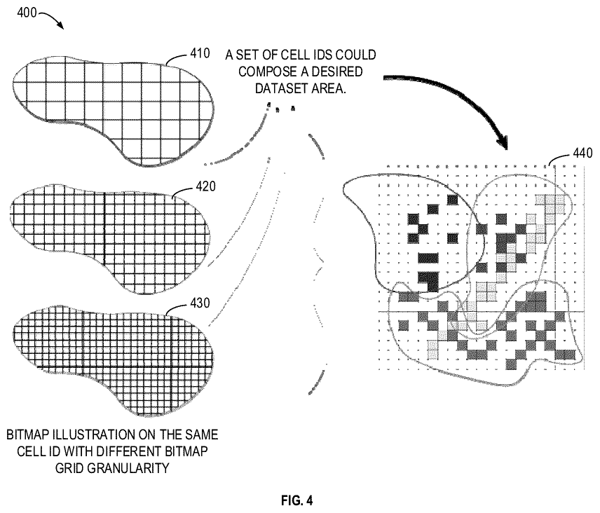

In FIG. 4, a representation of a cell-specific bitmap is shown. It illustrates the bitmap approach on every specific cell ID and the composition between different cell IDs to obtain a desired dataset area. The bitmap may be interpreted as a discretized position representation, where the discretization is on a grid with cell-specific granularity. As shown, a bitmap 410, a bitmap 420 and a bitmap 430 with the same cell ID may be divided with different grid granularities respectively, to indicate the location where data samples are collected by the terminal device. In some example embodiments, a set of cell IDs may compose a desired dataset area, e.g., a dataset corresponding to an aggregated bitmap 440, with bits set to one to indicate that data samples are collected in the corresponding locations.

### Example Methods

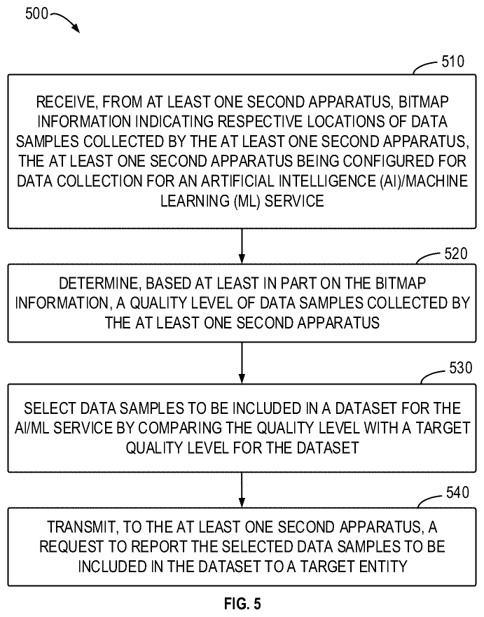

FIG. 5 shows a flowchart of an example method 500 implemented at a first apparatus in accordance with some example embodiments of the present disclosure. For the purpose of discussion, the method 500 will be described from the perspective of the DCM 110 or the LMF 120 in FIG. 1. For convenience, the following will take the LMF 120 as an example to describe the example embodiments of the present disclosure.

At block 510, the LMF 120 receives, from at least one second apparatus, bitmap information indicating respective locations of data samples collected by the at least one second apparatus, the at least one second apparatus being configured for data collection for an artificial intelligence (AI)/machine learning (ML) service.

At block 520, the LMF 120 determines, based at least in part on the bitmap information, a quality level of data samples collected by the at least one second apparatus.

At block 530, the LMF 120 selects data samples to be included in a dataset for the AI/ML service by comparing the quality level with a target quality level for the dataset.

At block 540, the LMF 120 transmits, to the at least one second apparatus, a request to report the selected data samples to be included in the dataset to a target entity.

In some example embodiments, the method 500 further comprises: in accordance with a determination that the quality level fails to satisfy the target quality level, the LMF 120 transmits, to the at least one second apparatus, a request to update the collected data samples; receives, from the at least one second apparatus, updated bitmap information indicating respective locations where the updated data samples are collected by the at least one second apparatus; updates the quality level based at least in part on the updated bitmap information; and selecting data samples to be included in the dataset for the AI/ML service by further comparing the updated quality level with the target quality level.

In some example embodiments, the method 500 further comprises: in accordance with a determination that the quality level satisfies the target quality level, the LMF 120 selects data samples to be included in the dataset for the AI/ML service from data samples indicated by the bitmap information.

In some example embodiments, the target quality level is determined based on a usage of the dataset in the AI/ML service.

In some example embodiments, the method 500 further comprises: the LMF 120 transmits, to the at least one second apparatus, confirmation information related to the data samples to be included in the dataset, the confirmation information at least comprising the bitmap information used for selecting the data samples.

In some example embodiments, the bitmap information from a second apparatus comprises a plurality of bits corresponding to a plurality of location grids within a geographic area, respectively, and a bit is set with a first value or a second value to indicate whether a data sample is collected by the second apparatus in a corresponding location grid.

In some example embodiments, a grid granularity for the plurality of location grids within the geographic area is determined based on a requirement for the dataset.

In some example embodiments, the method 500 further comprises: the LMF 120 receives, from the at least one second apparatus, identification information indicating at least one geographic area where the data samples are collected; determines, based on the identification information, an aggregated area within which data samples are selected to be included in the dataset; and selects the data samples that are collected within the aggregated area.

In some example embodiments, the method 500 further comprises: the LMF 120 determines, based at least in part on the bitmap information, at least one of the following: a first quality sub-level corresponding to a dataset distribution requirement of the dataset, a second quality sub-level corresponding to a density requirement of the dataset, a third quality sub-level corresponding to a radio quality requirement of the dataset, and a fourth quality sub-level corresponding to a target dataset size required by the dataset; and determines the quality level based on a weighted aggregation of the at least one of the first, second, third, and fourth quality sub-levels.

In some example embodiments, the method 500 further comprises: the dataset distribution requirement indicates a uniform distribution of data samples, and the LMF 120 determines an overall distribution of the data samples collected by the at least one second apparatus based on the bitmap information; and determines the first quality sub-level based on a similarity between the determined distribution and the uniform distribution.

In some example embodiments, the method 500 further comprises: the LMF 120 determines, based on the bitmap information, a total number of data samples collected by the at least one second apparatus and a total area size where data samples collected by the at least one second apparatus; determines a density of data samples collected by the at least one second apparatus based on the total number of data samples and the total area size; and determines the second quality sub-level based on a difference between the determined density and the density requirement.

In some example embodiments, the third quality sub-level comprises a target radio quality range configured for the at least one second apparatus to select the data samples indicated in the bitmap information.

In some example embodiments, the method 500 further comprises: the LMF 120 transmits, to the at least one second apparatus, requirement information for data collection, the requirement information at least indicating the target radio quality range.

In some example embodiments, the method 500 further comprises: the LMF 120 determines, based on the bitmap information, a total number of data samples collected by the at least one second apparatus; and determines the fourth quality sub-level by comparing the determined total number of data samples to the target dataset size required by the dataset.

In some example embodiments, the quality level is determined based on a weighted aggregation of at least one of the first, second, and third quality sub-levels; and

the LMF 120 determines whether a total number of data samples collected by the at least one second apparatus satisfy a target dataset size required by the dataset; and in accordance with a determination that the total number of data samples satisfies the target dataset size and in accordance with a determination that the quality level satisfies the target quality level, selects data samples to be included in the dataset.

In some example embodiments, the first apparatus comprises a location management function (LMF), and the at least one second apparatus comprises at least one of a terminal device or a positioning reference unit (PRU).

In some example embodiments, the AI/ML service comprises an AI/ML positioning service.

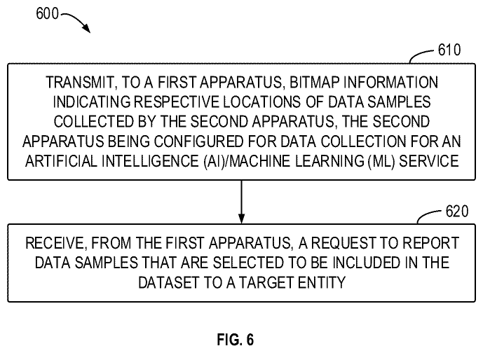

FIG. 6 shows a flowchart of an example method 600 implemented at a second apparatus in accordance with some example embodiments of the present disclosure. For the purpose of discussion, the method 600 will be described from the perspective of the UE 130, the PRU 140 or the LMF 150 in FIG. 1. For convenience, the following will take the UE 130 as an example to describe the example embodiments of the present disclosure.

At block 610, the UE 130 transmits, to a first apparatus, bitmap information indicating respective locations of data samples collected by the second apparatus, the second apparatus being configured for data collection for an artificial intelligence (AI)/machine learning (ML) service.

At block 620, the UE 130 receives, from the first apparatus, a request to report data samples that are selected to be included in the dataset to a target entity.

In some example embodiments, the method 600 further comprises: the UE 130 receives, from the first apparatus, a request to update the collected data samples; and transmits, to the first apparatus, updated bitmap information indicating respective locations where the updated data samples are collected by the second apparatus.

In some example embodiments, the method 600 further comprises: the UE 130 receives, from the first apparatus, confirmation information related to the data samples to be included in the dataset, the confirmation information at least comprising the bitmap information used for selecting the data samples.

In some example embodiments, the bitmap information from a second apparatus comprises a plurality of bits corresponding to a plurality of location grids within a geographic area, respectively, and a bit is set with a first value or a second value to indicate whether a data sample is collected by the second apparatus in a corresponding location grid.

In some example embodiments, a grid granularity for the plurality of location grids within the geographic area is determined based on a requirement for the dataset.

In some example embodiments, the method 600 further comprises: the UE 130 transmits, to the first apparatus, identification information indicating a geographic area where the data samples are collected.

In some example embodiments, the method 600 further comprises: the UE 130 receives, from the first apparatus, requirement information for data collection, the requirement information at least indicating a target radio quality range corresponding to a radio quality requirement of the dataset; and selects the data samples to be indicated in the bitmap information according to the requirement information.

In some example embodiments, the method 600 further comprises: the UE 130 selects the data samples with respective radio qualities within the target radio quality range.

In some example embodiments, the first apparatus comprises a location management function (LMF), and the at least one second apparatus comprises at least one of a terminal device or a positioning reference unit (PRU).

In some example embodiments, the AI/ML service comprises an AI/ML positioning service.

### Example Apparatus, Device and Medium

In some example embodiments, a first apparatus capable of performing any of the method 500 (for example, the DCM 110 or the LMF 120 in FIG. 1) may comprise means for performing the respective operations of the method 500. The means may be implemented in any suitable form. For example, the means may be implemented in a circuitry or software module. The first apparatus may be implemented as or included in the DCM 110 or the LMF 120 in FIG. 1.

In some example embodiments, the first apparatus comprises: means for receiving, from at least one second apparatus, bitmap information indicating respective locations of data samples collected by the at least one second apparatus, the at least one second apparatus being configured for data collection for an artificial intelligence (AI)/machine learning (ML) service; means for determining, based at least in part on the bitmap information, a quality level of data samples collected by the at least one second apparatus; means for selecting data samples to be included in a dataset for the AI/ML service by comparing the quality level with a target quality level for the dataset; and means for transmitting, to the at least one second apparatus, a request to report the selected data samples to be included in the dataset to a target entity.

In some example embodiments, the first apparatus further comprises: means for in accordance with a determination that the quality level fails to satisfy the target quality level, transmitting, to the at least one second apparatus, a request to update the collected data samples; means for receiving, from the at least one second apparatus, updated bitmap information indicating respective locations where the updated data samples are collected by the at least one second apparatus; means for updating the quality level based at least in part on the updated bitmap information; and means for selecting data samples to be included in the dataset for the AI/ML service by further comparing the updated quality level with the target quality level.

In some example embodiments, the first apparatus further comprises: means for in accordance with a determination that the quality level satisfies the target quality level, selecting data samples to be included in the dataset for the AI/ML service from data samples indicated by the bitmap information.

In some example embodiments, the target quality level is determined based on a usage of the dataset in the AI/ML service.

In some example embodiments, the first apparatus further comprises: means for transmitting, to the at least one second apparatus, confirmation information related to the data samples to be included in the dataset, the confirmation information at least comprising the bitmap information used for selecting the data samples.

In some example embodiments, the bitmap information from a second apparatus comprises a plurality of bits corresponding to a plurality of location grids within a geographic area, respectively, and a bit is set with a first value or a second value to indicate whether a data sample is collected by the second apparatus in a corresponding location grid.

In some example embodiments, a grid granularity for the plurality of location grids within the geographic area is determined based on a requirement for the dataset.

In some example embodiments, the first apparatus further comprises: means for receiving, from the at least one second apparatus, identification information indicating at least one geographic area where the data samples are collected; means for determining, based on the identification information, an aggregated area within which data samples are selected to be included in the dataset; and means for selecting the data samples that are collected within the aggregated area.

In some example embodiments, the first apparatus further comprises: means for determining, based at least in part on the bitmap information, at least one of the following: a first quality sub-level corresponding to a dataset distribution requirement of the dataset, a second quality sub-level corresponding to a density requirement of the dataset, a third quality sub-level corresponding to a radio quality requirement of the dataset, and a fourth quality sub-level corresponding to a target dataset size required by the dataset; and means for determining the quality level based on a weighted aggregation of the at least one of the first, second, third, and fourth quality sub-levels.

In some example embodiments, the dataset distribution requirement indicates a uniform distribution of data samples, and wherein the first apparatus further comprises: means for determining an overall distribution of the data samples collected by the at least one second apparatus based on the bitmap information; and means for determining the first quality sub-level based on a similarity between the determined distribution and the uniform distribution.

In some example embodiments, the first apparatus further comprises: means for determining, based on the bitmap information, a total number of data samples collected by the at least one second apparatus and a total area size where data samples collected by the at least one second apparatus; means for determining a density of data samples collected by the at least one second apparatus based on the total number of data samples and the total area size; and means for determining the second quality sub-level based on a difference between the determined density and the density requirement.

In some example embodiments, the third quality sub-level comprises a target radio quality range configured for the at least one second apparatus to select the data samples indicated in the bitmap information.

In some example embodiments, the first apparatus further comprises: means for transmitting, to the at least one second apparatus, requirement information for data collection, the requirement information at least indicating the target radio quality range.

In some example embodiments, the first apparatus further comprises: means for determining, based on the bitmap information, a total number of data samples collected by the at least one second apparatus; and means for determining the fourth quality sub-level by comparing the determined total number of data samples to the target dataset size required by the dataset.

In some example embodiments, the quality level is determined based on a weighted aggregation of at least one of the first, second, and third quality sub-levels; and wherein the first apparatus further comprises: means for determining whether a total number of data samples collected by the at least one second apparatus satisfy a target dataset size required by the dataset; and in accordance with a determination that the total number of data samples satisfies the target dataset size and in accordance with a determination that the quality level satisfies the target quality level, selecting data samples to be included in the dataset.

In some example embodiments, the first apparatus comprises a location management function (LMF), and the at least one second apparatus comprises at least one of a terminal device or a positioning reference unit (PRU).

In some example embodiments, the AI/ML service comprises an AI/ML positioning service.

In some example embodiments, the first apparatus further comprises means for performing other operations in some example embodiments of the method 500 or the LMF 120 or DCM 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the UE 130, or the PRU 140 in FIG. 1 may comprise means for performing the respective operations of the method 600. The means may be implemented in any suitable form. For example, the means may be implemented in a circuitry or software module. The second apparatus may be implemented as or included in the UE 130, or the PRU 140 in FIG. 1.

In some example embodiments, the second apparatus comprises means for transmitting, to a first apparatus, bitmap information indicating respective locations of data samples collected by the second apparatus, the second apparatus being configured for data collection for an artificial intelligence (AI)/machine learning (ML) service; and means for receiving, from the first apparatus, a request to report data samples that are selected to be included in the dataset to a target entity.

In some example embodiments, the second apparatus further comprises: means for receiving, from the first apparatus, a request to update the collected data samples; and means for transmitting, to the first apparatus, updated bitmap information indicating respective locations where the updated data samples are collected by the second apparatus.

In some example embodiments, the second apparatus further comprises: means for receiving, from the first apparatus, confirmation information related to the data samples to be included in the dataset, the confirmation information at least comprising the bitmap information used for selecting the data samples.

In some example embodiments, the bitmap information from a second apparatus comprises a plurality of bits corresponding to a plurality of location grids within a geographic area, respectively, and a bit is set with a first value or a second value to indicate whether a data sample is collected by the second apparatus in a corresponding location grid.

In some example embodiments, a grid granularity for the plurality of location grids within the geographic area is determined based on a requirement for the dataset.

In some example embodiments, the second apparatus further comprises: means for transmitting, to the first apparatus, identification information indicating a geographic area where the data samples are collected.

In some example embodiments, the second apparatus further comprises: means for receiving, from the first apparatus, requirement information for data collection, the requirement information at least indicating a target radio quality range corresponding to a radio quality requirement of the dataset; and means for selecting the data samples to be indicated in the bitmap information according to the requirement information.

In some example embodiments, the second apparatus further comprises: means for selecting the data samples with respective radio qualities within the target radio quality range.

In some example embodiments, the first apparatus comprises a location management function (LMF), and the at least one second apparatus comprises at least one of a terminal device or a positioning reference unit (PRU).

In some example embodiments, the AI/ML service comprises an AI/ML positioning service.

In some example embodiments, the second apparatus further comprises means for performing other operations in some example embodiments of the method 600 or the UE 130 or PRU 140. In some example embodiments, the means comprises at least one processor; and at least one memory storing instructions that, when executed by the at least one processor, cause the performance of the second apparatus.

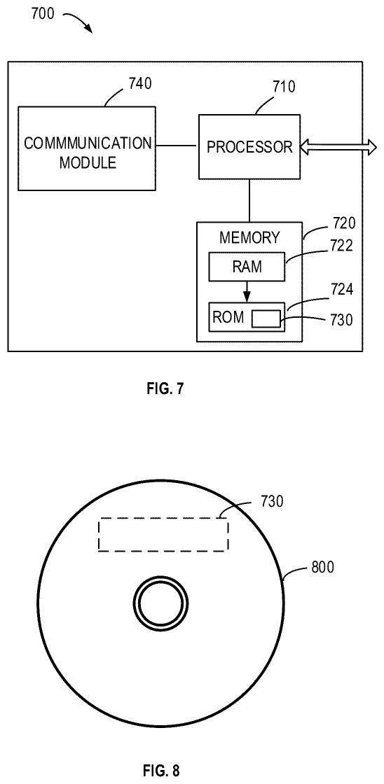

FIG. 7 is a simplified block diagram of a device 700 that is suitable for implementing example embodiments of the present disclosure. The device 700 may be provided to implement a communication device, for example, the DCM 110, the LMF 120, the, the UE 130, the PRU 140 or the LMF 150 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment.

Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

The abbreviations used herein are listed below together with their representation in unshortened form. It is noted that widely established and unique abbreviations can be assumed as known.

### List of Abbreviations

CIR channel impulse response
PDP power delay profile
DP delay profile
RSRP reference signal received power
RSRPP reference signal received power per path
TOA time of arrival
RSTD reference signal time difference
PRU positioning reference unit
DCM data collection management
KPI key performance indicator

1. A first apparatus comprising:
at least one processor; and
at least one memory storing instructions that, when executed by the at least one processor, cause the first apparatus at least to perform:
receiving, from at least one second apparatus, bitmap information indicating respective locations of data samples collected by the at least one second apparatus, the at least one second apparatus being configured for data collection for an artificial intelligence (AI)/machine learning (ML) service;
determining, based at least in part on the bitmap information, a quality level of data samples collected by the at least one second apparatus;
selecting data samples to be included in a dataset for the AI/ML service by comparing the quality level with a target quality level for the dataset; and
transmitting, to the at least one second apparatus, a request to report the selected data samples to be included in the dataset to a target entity.

2.-32. (canceled)
